(19) United States
(12) Patent Application Publication
(10) Pub. No.: US 2014/0158559 A1
(43) Pub. Date: Jun. 12, 2014

(54) PROTECTIVE CASE FOR PORTABLE ELECTRONIC DEVICE

(71) Applicants: FIH (HONG KONG) LIMITED, Kowloon (HK); SHENZHEN FUTAIHONG PRECISION INDUSTRY CO., LTD., Shenzhen (CN)

(72) Inventors: GANG YANG, Shenzhen (CN); YAN-LING GAO, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/973,101

(22) Filed: Aug. 22, 2013

(30) Foreign Application Priority Data
Dec. 10, 2012 (CN) 201210525659X

(51) Int. Cl. G06F 1/16

(52) U.S. Cl. CPC G06F 1/1633
USPC 206/37

(57) ABSTRACT

A protective case is used for protecting an electronic device. The protective case includes a first housing, a second housing, and a sealing member. The first housing defines a receiving groove, a first hole, and a second hole. The second housing is engaged with the first housing. The sealing member is latched in the receiving groove and covers the first hole and the second hole.

### BACKGROUND

1. Technical Field

The exemplary disclosure relates to cases for portable electronic devices, particularly, to a protective case for protecting portable electronic devices.

2. Description of Related Art

Protective cases are used to protect portable electronic devices of many different types and configurations, including but not limited to PDAs, tablet style personal computer (tablet PC), laptop computer, notebook, and personal stereos, thereby the display of the portable electronic devices can be protected when not in use. However, typical protective cases often have exposed ports and cannot ensure protection of the electronic device from dust or water.

Therefore, there is room for improvement within the art.

### BRIEF DESCRIPTION OF THE DRAWINGS

Many aspects of the protective case can be better understood with reference to the following drawings. The components in the drawings are not necessarily drawn to scale, the emphasis instead being placed upon clearly illustrating the principles of the protective case.

FIG. 1 is an exploded view of a protective case according to an exemplary embodiment.

FIG. 2 is an enlarged view of one part of the protective case of FIG. 1.

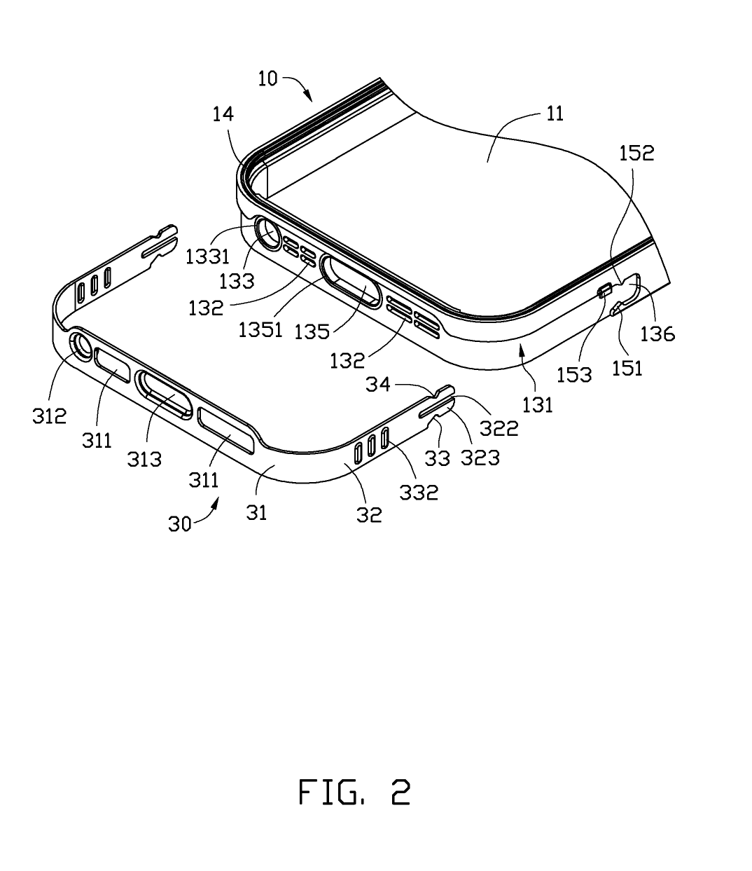

FIG. 3 is an assembled view of the protective case of FIG. 1.

FIG. 4 is a cross sectional view of the protective case of FIG. 3 taken along the line of IV-IV.

### DETAILED DESCRIPTION

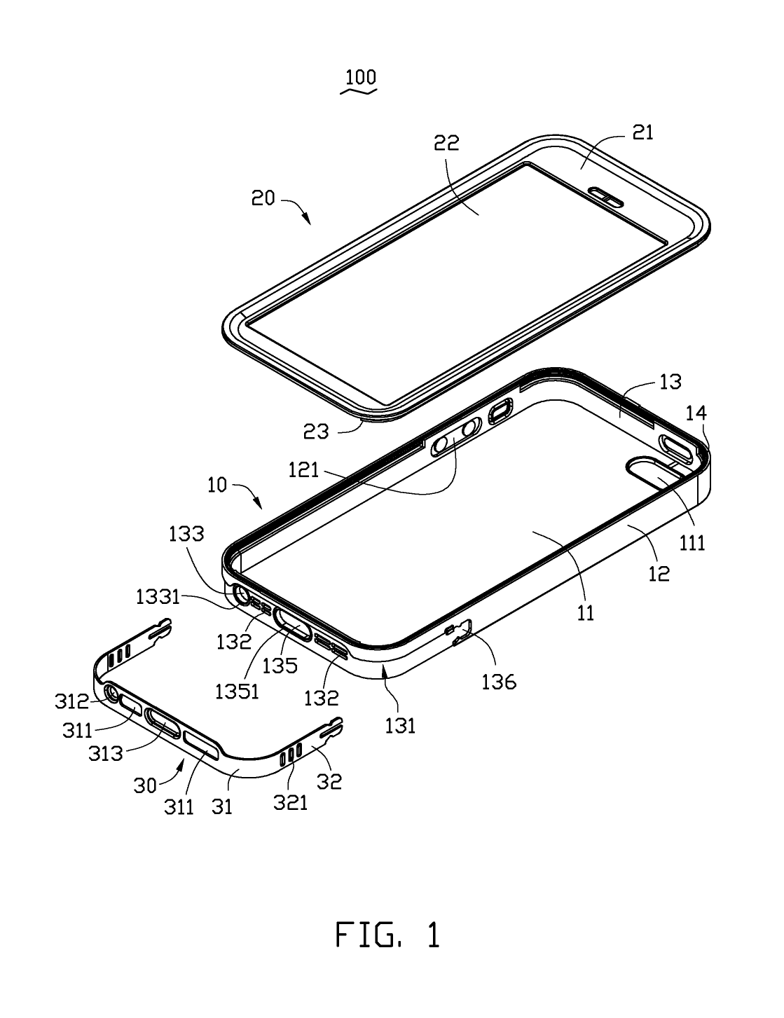

FIG. 1 shows an exemplary embodiment of a protective case 100. The case 100 is used to receive and protect an electronic device. The case 100 includes a first housing 10, a second housing 20, and a detachable sealing member 30.

The first housing 10 includes a main plate 11, two opposite sidewalls 12, and two opposite end walls 13. The two opposite sidewalls 12 and the two opposite end walls 13 protrude from a peripheral edge of the main plate 11 and surround the main plate 11, thereby cooperatively enclosing a receptacle configured for accommodating an electronic device. The main plate 11 defines a camera hole 111 for exposing a camera window of an electronic device. The first housing 10 has a plurality of shielding button portions 121 at the sidewalls 12 and the end walls 13 corresponding to buttons of an electronic device. The first housing 10 defines a latching groove 14 at a distal edge extending continuously around all sides of the two opposite sidewalls 12 and the two opposite end walls 13 configured for latching with the second housing 20.

The first housing 10 defines a receiving groove 131 at one of the two opposite end walls 13 and extending continuously toward the two opposite sidewalls 12. The receiving groove 131 has at least one microphone shielding portion 132, a first hole 133 and a second hole 135. In this exemplary embodiment, the first hole 133 is an earpiece plug hole, the second hole 135 is a USB hole, and there are two microphone shielding portions 132, respectively corresponding to the electronic device. The shielding microphone portions 132 are made of waterproof mesh, and are adhered to the first housing 10 by waterproof adhesive configured for covering microphones on the electronic device. The first hole 133 has a first sealing ring 1331, and the second hole 135 has a second sealing ring 1551. In this exemplary embodiment, the first, second sealing rings 1331 and 1551 are made of thermoplastic polyurethane (TPU), and are fabricated with the first housing 10 by dual-injection molding. The receiving groove 131 has two opposite latching ends 136. Each latching end 136 has a first latching block 151, a second latching block 152 and a stopper block 153. The first latching block 151 is positioned at one edge of the receiving groove 131, and the second latching block 152 and the stopper block 153 are positioned at another edge of the receiving groove 131 opposite to the first latching block 151.

The second housing 20 is configured for being latched with the first housing 10. The second housing 20 includes a cover body 21 and a window 22. The cover body 21 has an engaging portion 23 engaging in the latching groove 14. The window 22 is made of transparent material, and is integral with the cover body 21.

The sealing member 30 is substantially U-shaped, and is made of metal material. In this exemplary embodiment, the sealing member 30 is made of sheet brass. The sealing member 30 is engaged in the receiving groove 131, and includes a shielding portion 31 and two extending portions 32. The shielding portion 31 defines two spaced through holes 311, a first filling portion 312 and a second filling portion 313. The through holes 311 are configured so that the shielding microphone portions 132 are exposed. The shape of the first filling portion 312 corresponds to the first hole 133, and the shape of the second filling portion 313 corresponds to the second hole 135. The first filling portion 312 and the second filling portion 313 are integrally formed with the sealing member 30, and are configured for filling in the first hole 133 and the second hole 135. A plurality of ribs 321 protrude from each of the two extending portions 32 for conveniently operating the sealing member 30. A distal end of each extending portion 32 defines a cutout 322 and forms two elastic arms 323 at opposite sides. The cutout 322 allows the elastic arms 323 to be pressed toward each other. The two arms 323 have a first notch 33 and a second notch 34 at opposite sides for engaging with the first latching block 151 and the second latching block 152.

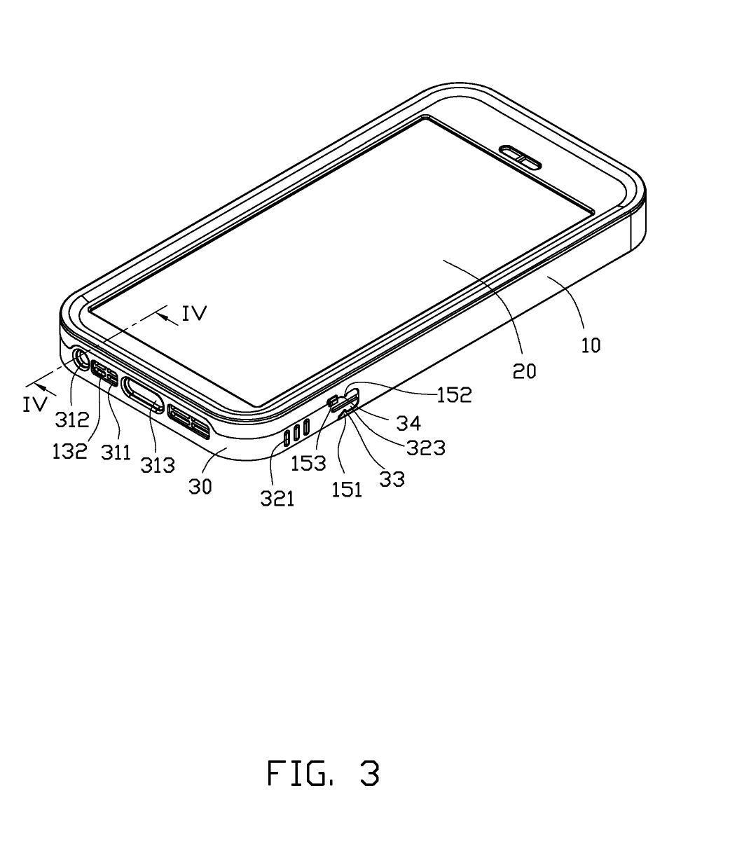

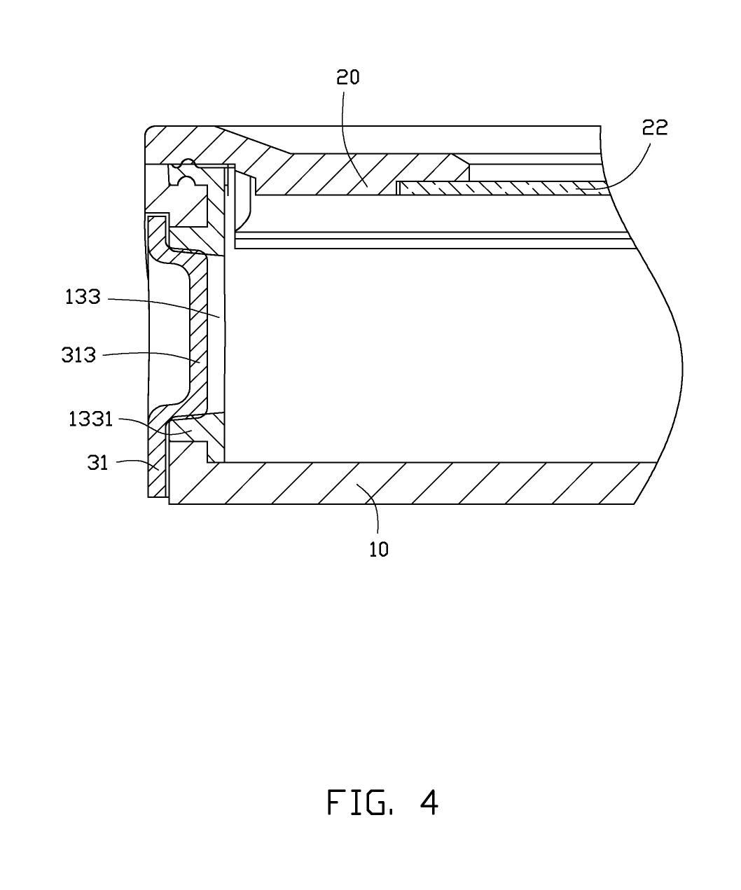

FIGS. 3 to 4 show that in use, an electronic device (not shown) is received in the receptacle of the first housing 10. The second housing 20 is positioned on the first housing 10. The window 22 is for the display of the electronic device to be exposed. The engaging portion 23 engages in the latching groove 14 to latch the second housing 20 with the first housing 10. The sealing member 30 is received in the receiving groove 131. The first filling portion 312 and the second filling portion 313 are filled in the first hole 133 and the second hole 135. Since the first and second sealing rings 1331, 1351 are made of soft material, the first filling portion 312 and the second filling portion 313 can press against the deformed first and second sealing rings 1331, 1351 to overlap each other for preventing contaminants from entering into the case 100. The two arms 323 of each extending portion 32 are engaged with the latching ends 136. The first latching block 151 and the second latching block 152 are respectively latched in the first notch 33 and the second notch 34 for latching the sealing member 30 with the first housing 10. The stopper block 153 covers one part of the sealing member 30 for preventing the sealing member 30 from separating from the first housing 10. The first filling portion 312 and the second filling portion 313 are filled in the first hole 133 and the second hole 135 for preventing contaminants from entering into the case 100. When the electronic device needs the use of an earpiece plug or USB port, the arms 323 are pressed and deformed to allow the first latching block 151 and the second latching block 152 to disengage from the first notch 33 and the second notch 34. Accordingly, the sealing member 30 is conveniently removed to expose earpiece plug and USB port. The protective case 100 seals the earpiece plug and the USB port of the electronic device to prevent impurities, such as dust or water, from going into electronic device.

Even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A protective case used for protecting an electronic device, the protective case comprising:
a first housing defining a receiving groove, a first hole, and a second hole;
a second housing engaged with the first housing; and
a sealing member latched in the receiving groove and covering the first hole and the second hole.

2. The protective case of claim 1, wherein the sealing member is substantially U-shaped, and is made of metal material.

3. The protective case of claim 2, wherein the sealing member is made of sheet brass.

4. The protective case of claim 1, wherein the sealing member includes a shielding portion and two extending portions, a first filling portion and a second filling portion are formed on the shielding portion, and the first filling portion and the second filling portion are respectively filled in the first hole and the second hole.

5. The protective case of claim 4, wherein each of the first hole and the second hole has a sealing ring made of thermoplastic polyurethane, and the first filling portion and the second filling portion pressed against the sealing rings.

6. The protective case of claim 4, wherein a plurality of ribs protrude from each of the two extending portions for conveniently operating the sealing member.

7. The protective case of claim 4, wherein each extending portion defines a cutout and two elastic arms at opposite sides of the cutout, and the receiving groove has two opposite latching ends engaging with the arms.

8. The protective case of claim 7, wherein each latching end has a first latching block, a second latching block positioned at opposite edges of the receiving groove, and the two arms have a first notch and a second notch at opposite sides for engaging with the first latching block and the second latching block.

9. The protective case of claim 8, wherein each latching end has a stopper block adjacent to the second latching block, and is opposite to the first latching block.

10. A protective case comprising:
a second housing defining a receiving groove, a first hole, and a second hole;
a second housing engaged with the first housing; and
a sealing member including a first filling portion and a second filling portion, the sealing member latched in the receiving groove, and the first filling portion and the second filling portion filled into the first hole and the second hole.

11. The protective case of claim 10, wherein the sealing member includes a shielding portion and two extending portions, and the first filling portion and the second filling portion are formed on the shielding portion.

12. The protective case of claim 11, wherein each extending portion defines a cutout and two elastic arms at opposite sides of the cutout, and the receiving groove has two opposite latching ends engaging with the arms.

13. The protective case of claim 12, wherein each latching end has a first latching block, a second latching block positioned at opposite edges of the receiving groove, and the two arms has a first notch and a second notch at opposite sides for engaging with the first latching block and the second latching block.
